(19) United States
(12) Patent Application Publication
(10) Pub. No.: US 2007/0097509 A1
(43) Pub. Date: May 3, 2007

(54) Optical elements for high contrast applications

(76) Inventors: Timothy J. Nevitt, Red Wing, MN (US); Andrew J. Ouderkirk, Woodbury, MN (US); Edward J. Kivel, Stillwater, MN (US)

Correspondence Address: 3M INNOVATIVE PROPERTIES COMPANY, PO BOX 33427, ST. PAUL, MN, 55133-3427, US

(21) Appl. No.: 11/263,259

(22) Filed: Oct. 31, 2005

(51) Int. Cl. G02B 1/10

(52) U.S. Cl. 359/584; 359/885

(57) ABSTRACT

The present application discloses optical elements for use in applications where high contrast is desirable. The optical elements comprise a multilayer optical film having a plurality of reflection bands at design wavelengths of incident light, wherein at least one of the reflection bands is a narrow reflection band, wherein each reflection band has a nominal spectral position at a design angle of incidence and wherein each reflection band shifts to a color-shifted reflection band for light incident at angles other than the design angles. The optical elements also comprise a wavelength selective absorber for absorbing at least one of the color-shifted reflection bands.

### FIELD OF THE INVENTION

The present application relates to optical elements for use as reflective components in high contrast applications.

### BACKGROUND

A variety of front projection screens are known. Present front projection screens work poorly in high ambient light conditions. For example, use of a projection system in a typical conference room requires the user to reduce the amount of ambient light in the room in order to see the projected image on the screen. Reducing ambient light in the room is one of the techniques for improving contrast. Other techniques for improving contrast in front projection screens include using polarized projector light sources (e.g. U.S. Pat. No. 6,381,068 (Harada et al.)), and preferentially reflecting, transmitting, or scattering light at the primary wavelengths (e.g. U.S. Pat. No. 6,529,332 (Jones et al.); U.S. Pat. No. 6,836,361 (Hou); 6,847,483 (Lippey et al.); and U.S. Patent Application Publication 2004/0240053 A1 (Shimoda)).

### SUMMARY

The present application discloses optical elements for use in projection screens and other applications where high contrast is desirable. In one aspect, the optical elements comprise a multilayer optical film having a plurality of reflection bands at design wavelengths of incident light, wherein at least one of the reflection bands is a narrow reflection band, wherein each reflection band has a nominal spectral position at a design angle of incidence and wherein each reflection band shifts to a color-shifted reflection band for light incident at angles other than the design angle. The optical elements also comprise a wavelength selective absorber for absorbing light in at least one of the color-shifted reflection bands.

In another aspect, the optical elements comprise a multilayer optical film including two interference stack reflectors, wherein the multilayer optical film has at least two narrow reflection bands for light at a first angle of incidence. The multilayer optical film can also have at least two color-shifted reflection bands for light at a second angle of incidence, and a wavelength selective absorbing (WSA) layer disposed between the two interference stack reflectors. The WSA layer can have an absorption edge selected to hide at least one of the color-shifted reflection bands.

In another aspect, the optical element comprises a blue-light reflecting interference stack, a green WSA disposed behind the blue-light reflecting interference stack, a green-light reflecting interference stack disposed behind the green edge absorber, a red WSA disposed behind the green-light reflecting interference stack, and a red-light reflecting interference stack disposed behind the red WSA.

The above summary of the present invention is not intended to describe each disclosed embodiment or every implementation of the present invention. These and other aspects of the present application will be apparent from the detailed description below. In no event should the above summaries be construed as limitations on the claimed subject matter. The claimed subject matter is defined solely by the attached claims, which may be amended during prosecution.

### BRIEF DESCRIPTION OF THE DRAWINGS

The invention may be more completely understood in consideration of the following detailed description in connection with the accompanying drawings, where like reference numerals designate like elements. The appended drawings are intended to be illustrative examples and are not intended to be limiting.

FIG. 1 is a schematic diagram of an exemplary multilayer optical film.

FIG. 1 a is a schematic diagram of an exemplary interference stack reflector.

FIG. 2 is graph illustrating reflection spectra of a multilayer optical film at normal incidence angles and at 40° incidence angles.

FIG. 3 is a schematic diagram of an exemplary projector and projection screen system.

FIG. 4a is a schematic diagram of an optical element.

FIG. 4b is a schematic diagram of another optical element.

FIG. 5 is a graph illustrating transmission spectra of various wavelength selective absorbers used in Examples 1 and 2.

FIG. 6 is a graph illustrating reflection spectra of an optical element of Example 1.

FIGS. 7a-b are graphs of luminous reflection efficiency and projector source reflection a* and b* values versus incidence angle for an optical element of Example 1.

FIGS. 8a-b are graphs illustrating reflection spectra of an optical element of Example 2.

FIGS. 9a-b are graphs of luminous reflection efficiency and projector source reflection a* and b* values versus incidence angle for an optical element of Example 2.

FIG. 10 is a graph showing an estimate of near-normal angle screen contrast ratio for various sizes of screens incorporating the optical element of Example 1.

FIG. 11 is a graph showing an estimate of near-normal angle screen contrast ratio for various sizes of screens incorporating the optical element of Example 2.

FIG. 12 is a graph illustrating estimated improvement in contrast ratio.

FIG. 13 is a graph showing reflection spectra of an optical element in another embodiment.

FIGS. 14a-b are graphs showing reflection spectra of optical elements in other embodiments.

### DETAILED DESCRIPTION

The present application discloses optical elements for use as reflective components in applications where increased contrast ratio is desirable. For example, the optical elements can be used in high contrast front projection screens, displays, and security applications. High contrast is achieved by reflecting the projected light while substantially absorbing ambient light. The reflection spectrum of the optical element can be tuned to the spectrum of the projector light source. The disclosed optical elements are designed to reflect light having only selected wavelengths and selected incidence angles (projected light) while substantially absorbing light having other wavelengths and angles (ambient light).

Optical elements disclosed in this application include multilayer optical films (MOFs), designed to selectively reflect certain narrow, targeted portions of the electromagnetic spectrum. Multilayer optical films can be designed to reflect only selected wavelengths of the spectrum while transmitting other wavelengths. For many applications (e.g. projection screens and other display systems), the selected wavelengths to be reflected will be in the visible range of the spectrum. However, optical elements can be designed to reflect other selected wavelengths including without limitation infrared (IR) and ultraviolet (UV) wavelengths. Examples of suitable multilayer optical films include inorganic multilayer optical films, co-extruded polymeric multilayer optical films, and multiple pitch cholesteric liquid crystal films.

Multilayer optical films are interference-based films that can be designed in the form of polarizers or mirrors. Polymeric or cholesteric multilayer optical films can be designed as reflective polarizers or mirrors. Inorganic multilayer optical films can be designed as mirrors. As referred to herein, MOF reflective polarizers substantially reflect light having one polarization of light, while substantially transmitting the other polarization. Cholesteric reflective polarizers reflect a chosen component (handedness) of circularly polarized light. Co-extruded polymeric reflective polarizers reflect linearly polarized light. MOF mirrors substantially reflect both polarizations of light.

Multilayer optical films, i.e., films that provide desirable transmission and/or reflection properties at least partially by an arrangement of microlayers of differing refractive index, are known. It has been known to make such multilayer optical films by depositing a sequence of inorganic materials in optically thin layers (“microlayers”) on a substrate in a vacuum chamber. Inorganic multilayer optical films are described in, for example, H. A. Macleod, Thin-Film Optical Filters, 2nd Ed., Macmillan Publishing Co. (1986) and A. Thelan, Design of Optical Interference Filters, McGraw-Hill, Inc. (1989).

More recently, multilayer optical films have been demonstrated by coextrusion of alternating polymer layers (see, e.g., U.S. Pat. No. 3,610,729 (Rogers), 4,446,305 (Rogers et al.), U.S. Pat. No. 4,540,623 (Im et al.), U.S. Pat. No. 5,448,404 (Schrenk et al.), and U.S. Pat. No. 5,882,774 (Joniza et al.)). In these co-extruded polymeric multilayer optical films, polymer materials are used predominantly or exclusively in the makeup of the individual layers. Such films are compatible with high volume manufacturing processes, and can be made in large sheets and roll goods.

Co-extruded polymeric multilayer optical films for use in optical filters are described in, for example, U.S. Pat. No. 5,882,774 (Jonza et al.); and PCT Publications WO95/17691; WO95/17692; WO95/17699; and WO99/36262. One commercially available form of a multilayer reflective polarizer is marketed as Dual Brightness Enhanced Film (DBEF) by 3M, St. Paul, Minn. Polymeric multilayer optical films are generally formed using alternating layers of polymer materials with different indices of refraction. Typically, any polymer can be used as long as the polymer is relatively transparent over the wavelength range of transmission. For polarizing applications, the first optical layers, the second optical layers, or both are formed using polymers that are or can be made birefringent. Birefringent polymers can also be used in non-polarizing applications.

Cholesteric liquid crystal optical films are described in, for example, U.S. Pat. No. 5,793,456, U.S. Pat. No. 5,506,704, U.S. Pat. No. 5,691,789, and European Patent Application Publication No. EP 940 705. One cholesteric reflective polarizer is marketed under the tradename TRANSMAX™ by Merck Co. Cholesteric liquid crystal optical films substantially reflect light having one circular polarization (e.g., left or right circularly polarized light) and substantially transmit light having the other circular polarization (e.g., right or left circularly polarized light) over a particular bandwidth of light wavelengths. This characterization describes the reflection or transmission of light directed at normal incidence to the director of the cholesteric liquid crystal material. Light that is directed at other angles will typically be elliptically polarized by the cholesteric liquid crystal material. Cholesteric materials can be composed of any known materials, including without limitation monomers and polymers.

The pitch of a cholesteric liquid crystal optical film is an important factor in determining the center wavelength and the spectral bandwidth of the light reflected by the cholesteric liquid crystal. The pitch for these optical films is analogous to layer thickness in the inorganic and co-extruded polymeric multilayer optical films. Using multiple pitch repeat units over a range of values typically increases the bandwidth of the optical film. Cholesteric liquid crystal optical films with multiple pitch units (for example, to increase bandwidth) can be formed, for example, by stacking cholesteric liquid crystal optical films made using different materials or different combinations of the same materials. An alternative is to form the optical film by varying the pitch through each of one or more layers. The different values of pitch act as different optical layers which reflect different wavelengths of light.

In addition, the number of pitch units, each with a particular pitch value, is analogous to the number of repeat units in the inorganic and co-extruded polymeric multilayer optical films. Typically, larger numbers of repeated pitch units in a cholesteric liquid crystal MOF result in higher reflectivity.

As used herein, “film” refers to an extended optical body whose thickness is generally much thinner than its lateral dimensions. In some instances a film can be attached or applied to another optical body such as a rigid substrate or another film having suitable reflection or transmission properties. The film can also be in a physically flexible form, whether it is free-standing or attached to other flexible layer(s).

A multilayer optical film typically comprises one or more interference stacks. Each interference stack comprises a coherent grouping of individual microlayers having different refractive index characteristics so that some light is reflected at interfaces between adjacent microlayers. The microlayers are sufficiently thin so that light reflected at a plurality of the interfaces undergoes constructive or destructive interference in order to give the interference stack the desired reflective or transmissive properties. For interference stacks designed to reflect light at ultraviolet, visible, or near-infrared wavelengths, each microlayer generally has an optical thickness (a physical thickness multiplied by refractive index) of less than about 1 μm. In this application, interference stacks designed to reflect light are referred to as interference stack reflectors. Thicker layers can also be included in the design, such as skin layers at the outer surfaces of the interference stack reflector, or protective boundary layers disposed between the interference stacks that separate coherent groupings of microlayers. A multilayer optical film can also comprise one or more thick adhesive layers to bond two or more sheets of interference stack reflectors in a laminate.

In a simple embodiment, the microlayers can have thicknesses corresponding to a ¼-wave stack, i.e., arranged in optical repeat units or unit cells each consisting essentially of two adjacent microlayers of equal optical thickness (f-ratio =50%), such optical repeat unit being effective to reflect by constructive interference light whose wavelength X is twice the overall optical thickness of the optical repeat unit. Thickness gradients along a thickness axis of the film (e.g., the z-axis) can be used to provide a widened reflection band. Thickness gradients tailored to sharpen such band edges can also be used, as discussed in U.S. Pat. No. 6,157,490 (Wheatley et al.). For co-extruded polymeric multilayer optical films, reflection bands can be designed to have sharpened band edges as well as ‘flat top’ reflection bands. Other layer arrangements, such as multilayer optical films having 2-microlayer optical repeat units whose f-ratio is different from 50%, or films whose optical repeat units consist essentially of more than two microlayers, are also contemplated. These alternative optical repeat unit designs can be designed to enhance or diminish certain higher-order reflections. See, e.g., U.S. Pat. No. 5,360,659 (Arends et al.) and U.S. Pat. No. 5,103,337 (Schrenk et al.).

Multilayer optical films can be designed to reflect one or both polarizations of light over at least one spectral band known as a reflection band. The films can also be tailored to exhibit a sharp bandedge at one or both sides of the reflection band(s), thereby giving a high degree of color saturation. The layer thicknesses and indices of refraction of the interference stacks within the multilayer optical films can be controlled to reflect at least one polarization of specific wavelengths of light (at a particular angle of incidence) while being substantially transparent over other wavelengths. Through careful manipulation of these layer thicknesses and indices of refraction along the various film axes, a multilayer optical film can be made to behave as a mirror or reflective polarizer over one or more regions of the spectrum. Thus, for example, multilayer optical films can be tuned to reflect both polarizations of light in the visible region of the spectrum while being transparent over other portions of the spectrum, thereby making them particularly suitable for use in projection screens.

Exemplary materials that can be used in the fabrication of co-extruded polymeric multilayer optical film can be found in U.S Pat. No. 6,827,886 (Neavin et al.). Exemplary two-polymer combinations that provide both adequate refractive index differences and adequate inter-layer adhesion include: (1) for polarizing multilayer optical film made using a process with predominantly uniaxial stretching, PEN/coPEN, PET/coPET, PEN/sPS, PET/sPS, PEN/Eastar,™ and PET/Eastar,™ where “PEN” refers to polyethylene naphthalate, “coPEN” refers to a copolymer or blend based upon naphthalene dicarboxylic acid, “PET” refers to polyethylene terephthalate, “coPET” refers to a copolymer or blend based upon terephthalic acid, “sPS” refers to syndiotactic polystyrene and its derivatives, and Eastar™ is a polyester or copolyester (believed to comprise cyclohexanedimethylene diol units and terephthalate units) commercially available from Eastman Chemical Co.; (2) for polarizing multilayer optical film made by manipulating the process conditions of a biaxial stretching process, PEN/coPEN, PEN/PET, PEN/PBT, PEN/PETG and PEN/PETcoPBT, where “PBT” refers to polybutylene terephthalate, “PETG” refers to a copolymer of PET employing a second glycol (usually cyclohexanedimethanol), and “PETcoPBT” refers to a copolyester of terephthalic acid or an ester thereof with a mixture of ethylene glycol and 1,4-butanediol; (3) for mirror films (including colored mirror films), PEN/PMMA, coPEN/PMMA, PET/PMMA, PEN/Ecdel,™ PET/Ecdel,™ PEN/sPS, PET/sPS, PEN/coPET, PEN/PETG, and PEN/THV,™ where “PMMA” refers to polymethyl methacrylate, Ecdel™ is a copolyester ether elastomer commercially available from Eastman Chemical Co., and THV™ is a fluoropolymer commercially available from 3M Company.

Further details of suitable multilayer optical films and related designs and constructions can be found in U.S. Pat. No. 5,882,774 (Jonza et al.), U.S. Pat. No. 6,531,230 (Weber et al.), PCT Publication WO 99/39224 (Ouderkirk et al.), and “Giant Birefringent Optics in Multilayer Polymer Mirrors”, Science, Vol. 287, March 2000 (Weber et al.). Multilayer optical films and film bodies can comprise additional layers and coatings selected for their optical, mechanical, and/or chemical properties. For example, a UV absorbing layer can be added at the incident side of the optical element to protect components of a projection screen having such an optical element from degradation caused by UV light. Additional layers and coatings could also include scratch resistant layers, tear resistant layers, and stiffening agents. See e.g. U.S. Pat. No. 6,368,699 (Gilbert et al.).

Multilayer optical films designed to reflect one or more narrow bands of visible light typically transmit most of the other visible wavelengths. The absorption of such films is usually low enough to be ignored, so that to a good approximation the sum of the amount of light reflected (R) and the amount of light transmitted (T) equals the total amount of incident light.

In context of this application, a reflection band is a spectral region of high reflection bounded by spectral regions of low reflection (high transmission). Nevertheless, even in a transmission band of a given MOF, a small amount of reflection may occur. A reflection band can be characterized by having a center wavelength and width. The center wavelength is the wavelength at the center of the reflection band, often (but not necessarily) close to the wavelength at which the reflectance band has its peak reflectance value. The width of a reflection band can be expressed as full width at half maximum (FWHM), which is the distance, in nm, between the two wavelengths within the band which are at 50 percent of the maximum reflection value.

Multilayer optical films used herein typically have a plurality of reflection bands, where at least one of the reflection bands is a narrow reflection band, preferably 50 nm in width or less. The wavelength locations of the narrow reflection bands can, if used with a suitable light source, provide high-brightness, color-true reflection of a projected image. The multilayer optical film acts as the reflective component of an optical element in a front projection screen or other high contrast application. A multilayer optical film that includes a plurality of reflection bands extending over selected visible wavelengths of light incident at the design angles can be used to reflect targeted portions of the projected light.

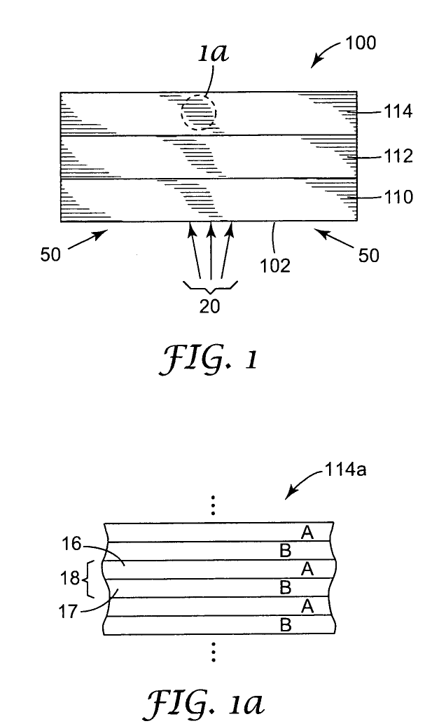

FIG. 1 shows an exemplary multilayer optical film 100, having three distinct interference stack reflectors 110, 112, and 114. Each interference stack reflector comprises optical repeat units of alternating polymeric microlayers, inorganic microlayers, or multiple pitch cholesteric liquid crystals. Figure la shows one example of an interference stack reflector having alternating layers A and B (16 and 17, respectively). Each repeating group of microlayers, in this case AB, forms an optical repeat unit 18. Other interference stack designs are also contemplated, including those having optical repeat units known in the art. For example, optical repeat units having more than two microlayers (e.g. ABC; CACDBD; 7A1B1A7B1A1B) are also contemplated.

In one embodiment designed as shown in FIG. 1, the three interference stack reflectors 110, 112, and 114 are chosen to reflect blue, green, and red light, respectively. The three reflected primary colors can be mixed to achieve essentially any color on the display. In FIG. 1, a first interference stack reflector 110 designed to reflect blue light is shown closest to an incident side 102 of the multilayer optical film 100. Incident light includes projector light 20 and ambient light 50. A second interference stack reflector 112 designed to reflect green light is disposed behind the blue-light reflecting interference stack 110, as viewed from the incident side 102 of the multilayer optical film. A third interference stack reflector 114 designed to reflect red light is disposed behind the green-light reflecting interference stack 112.

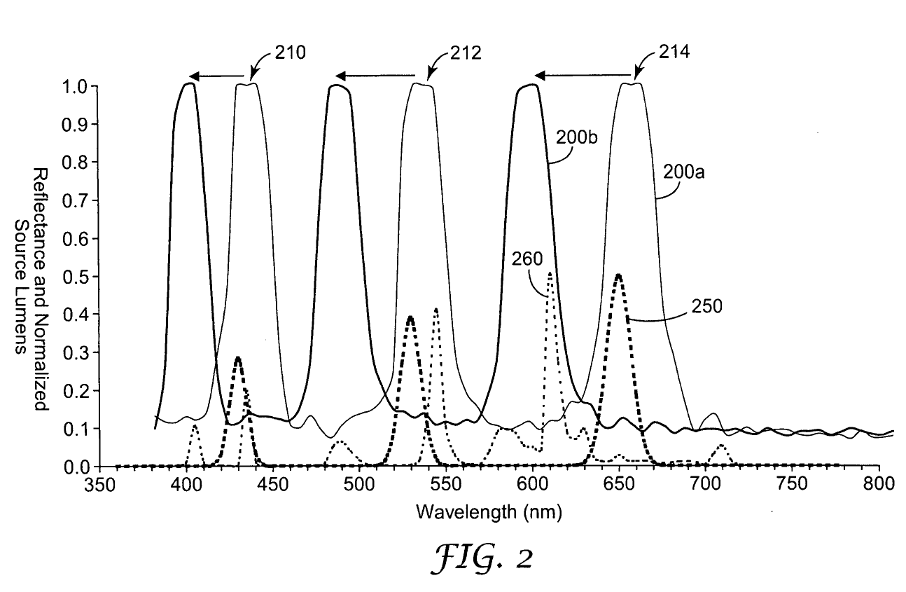

FIG. 2 shows a reflection spectrum 200a for a co-extruded polymeric multilayer optical film constructed as shown in FIG. 1. Reflection spectrum 200a has three narrow reflection bands 210, 212, and 214, one in the blue (210), one in the green (212), and one in the red (214) region of the spectrum, as well as intervening transmission bands between the reflection bands. Each of the reflection bands is approximately 30 nm in width.

One of the properties of multilayer optical films is that the reflection bands shift with incidence angle. For light incident at normal or near-normal angles, the reflection bands are located at one set of wavelength ranges. For light incident at oblique angles, these reflection bands shift to shorter wavelengths. For example, in a multilayer optical film designed to have a reflection band at green wavelengths at normal incidence, that green reflection band will shift towards blue wavelengths as the angle of incident light increases. In FIG. 2, at normal incidence, the red reflection band 214 reflects wavelengths between 640 nm and 670 nm. For light incident at 40°, this red reflection band shifts to 585-615 nm, as shown by curve 200b. The color-shifting property of multilayer optical films is described in detail in U.S. Pat. No. 6,531,230 (Weber et al.).

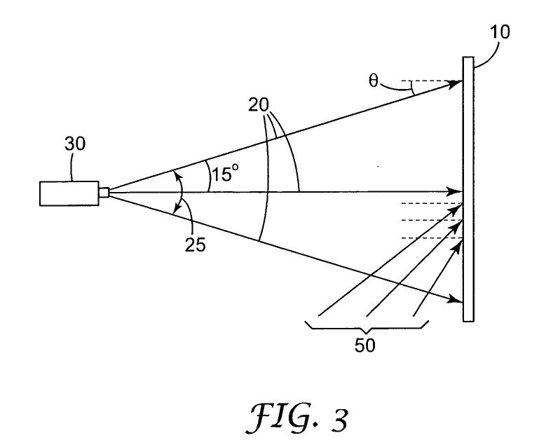

FIG. 3 shows an embodiment including a projector light source 30 emitting light 20 incident on a screen 10, at design angle θ. The screen 10 includes an optical element comprising a reflective component. The projected light 20 is incident in an angular range 25 having a half-cone angle of 15°. Angles within this range are typically referred to as near-normal and include light incident at normal or 0°. The center angle of the angular cone is the design angle θ (0° in the embodiment shown). The particular wavelength ranges to be reflected by the optical element can be tuned to the emission wavelengths of the projector light source 30. Typical projector light sources include ultra-high pressure short arc lamps filled with xenon or mercury containing gasses, and laser sources including VCSEL, fiber lasers, edge emitting lasers, solid state direct wavelength generation lasers, non-linear optic wavelength generation lasers, diode pumped optical glasses and crystals, including Nd:YAG and YLF. LED sources can also be used as projector light sources. For example, a projector light source having red, green, and blue LEDs can be used. Often, the projector light source is filtered by absorbing or reflecting dichroic elements in the image generating process, further refining the projector light spectrum to best match the required spectral content of the projected image.

The reflection bands of the optical element in a projection screen can then be selected such that the reflection bands are centered on the corresponding high output peaks of the projected light spectrum, as will be described below. In some embodiments, the peaks of the projected light can only partially overlap the reflection peaks of the optical element.

Projector light can be polarized or unpolarized. In the case of an optical element including a reflective polarizer multilayer optical film, a polarized light source can be used. The optical element can be constructed to be reflective in only one polarization state (linearly or circularly polarized), and highly transmissive (across the visible band) for the other polarization state. This can be advantageous if the projector source outputs linearly or circularly polarized light, and where the projector polarization and the screen reflection polarization are co-aligned. An example of an optical element using a co-extruded polymeric reflective polarizer MOF is described in Example 2.

A multilayer optical film constructed as shown in FIG. 1 can be used as a component of a projection screen in a projection system of FIG. 3 to achieve targeted reflection of projected light. However, a screen of this design tends to reflect a substantial amount of ambient light, contributing to reduced contrast. Referring for example, to FIG. 2, red light projected at 650 nm in the near-normal angles is reflected by the red MOF reflection band (640-670 nm). Ambient light 50, having the same wavelength of 650 nm is also reflected when incident at near-normal angles. At higher, oblique angles of incidence, the ambient light is transmitted by the MOF as the red reflection band shifts to wavelengths shorter than 650 nm. On the other hand, ambient light in wavelengths matching the color-shifted reflection band, incident at oblique angles will be reflected by the MOF. This reflection of ambient light at angles other than the design angle contributes to low contrast. Contrast is determined by the ratio of the amount of projected light that is reflected by the screen to the amount of ambient light reflected. Thus one way of increasing contrast ratio is to reduce the amount of ambient light reflected by the optical element.

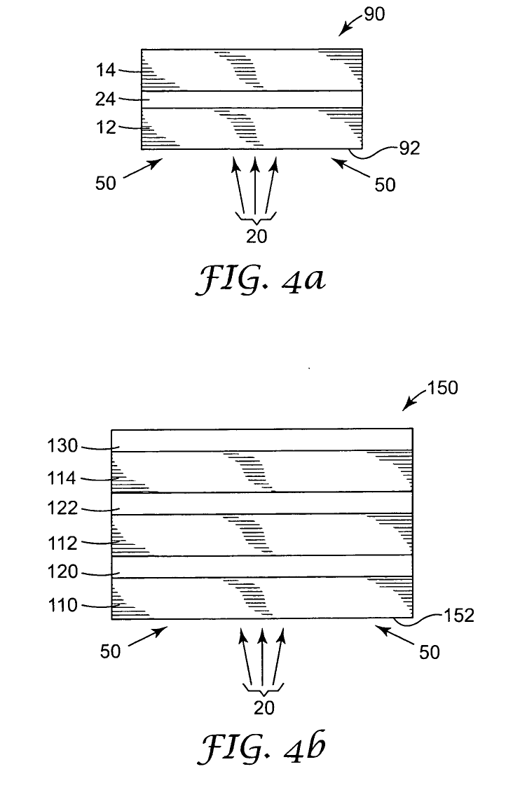

To increase contrast, the color-shifted reflection band of the optical element can be hidden by adding a wavelength selective absorber (WSA). FIG. 4a shows a schematic diagram of an optical element having two interference stack reflectors 12 and 14 and a wavelength selective absorbing layer 24 positioned between the reflectors 12 and 14. The WSA layer 24 is selected to have an absorbing edge located at a wavelength between the reflection band of the design angle and the color-shifted reflection band for a given color-reflecting interference stack. With this design, the color-shifted reflection band can be effectively hidden by the wavelength selective absorber.

In an exemplary embodiment, the interference stack reflector 14 can be selected to reflect red light, with a center wavelength of 660 nm, as shown in FIG. 2. A red WSA layer 24 can be selected to have an absorbing edge located at approximately 620 nm and positioned in front of the red-light reflecting interference stack 14. The red WSA layer absorbs wavelengths shorter than 620 nm. With this design, light that would otherwise have been reflected by the color-shifted band of the red-light reflecting interference stack (centered at approximately 600 nm for 40° incidence) is absorbed by the red wavelength selective absorber, thereby reducing the amount of ambient light reflected by the optical element.

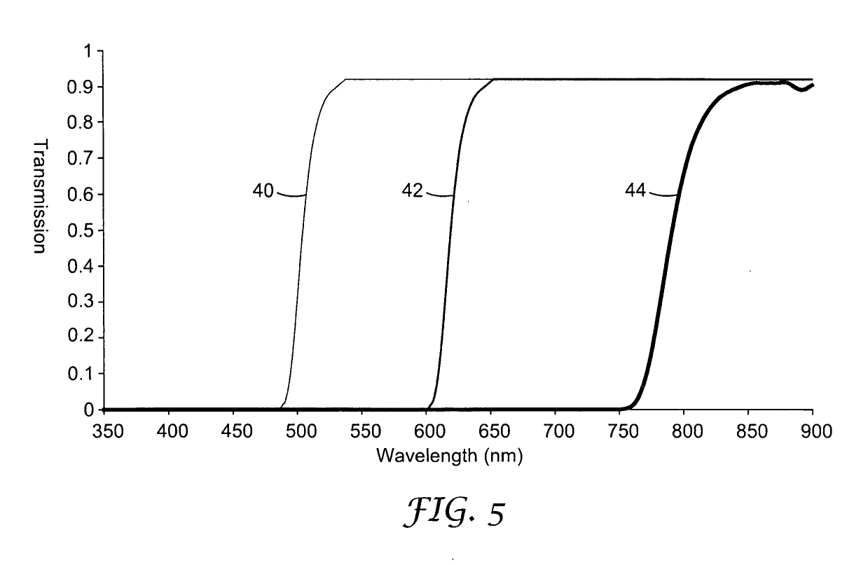

Since wavelength selective absorbers are substantially angle-independent, light having the selected wavelengths entering the screen at any angle will be absorbed. Wavelength selective absorbers can be chosen to have a single absorption edge so that light at wavelengths below the absorption edge is absorbed and light with wavelengths above the absorption edge is transmitted. FIG. 5 shows examples of spectra for such wavelength selective absorbers. In FIG. 5, transmission spectra for three exemplary wavelength selective absorbers are shown. Transmission spectrum for a green WSA having an absorption edge around 505 nm is shown as curve 40, a red WSA having an absorption edge around 620 nm is shown as curve 42, and a black WSA having an absorption edge around 780 nm is shown as curve 44.

Alternatively, a wavelength selective absorber can transmit below and absorb above an absorption edge. A combination of the two can also be designed so that the wavelength selective absorber absorbs in a selected range of wavelengths and transmits both below and above that range. One or more of such wavelength selective absorbers can be used to hide a color-shifted reflection band.

In the embodiments including red, green, and blue reflection bands, the order of the red, green, and blue-light reflecting interference stacks and WSA layers can be carefully arranged so that ambient light incident at angles outside of the design angles is absorbed. For an optical element designed to reflect near-normal angles of incidence, if the red-light reflecting interference stack and the red WSA layer are placed on the incident side of the screen, all wavelengths shorter than the red absorption edge of 620 nm will be absorbed. Thus, light in the blue and green wavelengths (around 430 nm and 530 nm, respectively) would be absorbed before having a chance to reach the blue and green-light reflecting interference stacks and would not be reflected by an optical element of this design.

FIG. 4b shows an embodiment where the MOF layers (interference stack reflectors) and WSA layers are arranged to reflect the three selected primary colors at near-normal incidence while absorbing unwanted ambient light incident at angles that are not near-normal, including the color-shifted wavelengths corresponding to two of the three interference stack reflectors.

A blue-light reflecting interference stack 110 is placed on the incident side 152 of the optical element. The blue-light reflecting interference stack is designed to reflect wavelengths between 430 and 460 nm at normal and near-normal incidence, as shown in FIG. 2 (curve 200a). At 40°, the color-shifted blue reflection band resides at about 390-420 nm. In this embodiment, the color-shifted blue reflection band is not hidden by a wavelength selective absorber, because these reflected blue wavelengths are desirable for reasons relating to color-composition and the eye's reduced sensitivity to deep-blue wavelengths. In other embodiments, a blue WSA layer can be added in front of the blue-light reflecting interference stack. Additional layers or coatings can also be added, including UV absorbing layers, scratch resistant layers, and so on, as described previously.

A green-light reflecting interference stack 112 is placed behind the blue-light reflecting interference stack 110. The green-light reflecting interference stack is designed to reflect wavelengths between 520 and 550 mn at normal and near normal incidence. The color-shifted green reflection band resides at about 480-510 nm. To hide the green color-shifted reflection band, a green wavelength selective absorbing (WSA) layer 120 is added. The green WSA layer has an absorption edge at about 505 nm (see FIG. 5, curve 40). The green WSA layer 120 is positioned between the blue-reflecting and green-reflecting MOF layers, respectively, so that light having wavelengths shorter than 505 nm is absorbed and light having wavelengths longer than 505 nm is transmitted through the green WSA layer 120. Light matching the reflection band wavelengths of the green-reflecting interference stack 112 is subsequently reflected by the green-reflecting interference stack 112.

Similarly, a red-light reflecting interference stack 114 is placed behind the green-light reflecting interference stack 112. The red-reflecting interference stack 114 is designed to reflect wavelengths between 640 and 670 nm at near-normal incidence. At 40° the color-shifted red reflection band resides at about 585-615 nm. To hide this reflection band, a red WSA layer 122 is added between the green-reflecting and red-reflecting MOF layers. Optionally, a black absorbing layer 130 can be added behind the red-light reflecting interference stack 114 to absorb any light that may be transmitted by the combination of the other layers. Optionally, the optical element can also include a front diffusive layer in order to backscatter the projected image into a suitable range of viewing angles. Optical elements are characterized by an angular distribution of reflected light. When a different angular distribution of light is desired for a particular application, a diffusing element can be added to modify the angular distribution of light.

In front projection screen applications, the projected image is typically incident upon the screen at a range of design angles that are near-normal. Other embodiments also exist where the projected light can be incident at a specific design angle. Systems having a projector or light source positioned such that the light is incident on the projection screen at a design angle, for example 30°, can be constructed. In such a system, the color-shifted reflection bands of the multilayer optical film move towards longer wavelengths as incident light angles change towards normal. For light incident at angles higher than 30°, the reflection band shifts toward shorter wavelengths as described previously.

For an optical element designed to reflect the projector light at a design angle of 30°, a different combination of wavelength selective absorbers can be selected to hide the higher wavelength color-shifted reflection bands. For example, a green-light reflecting interference stack designed to reflect wavelengths of 490-520 nm at about 30° may have a color-shifted reflection band at longer wavelengths (e.g. 530-560 nm) for normal incidence light. A wavelength selective absorber positioned in front of the interference stack reflector and selected to transmit wavelengths below 530 nm but absorb from 530 nm to 600 nm could be used to hide the color-shifted reflection band at normal incidence.

In the 30° design angle embodiment, a second color-shifted reflection band may also exist for higher incidence angles. This second color-shifted reflection band would be shifted towards shorter wavelengths. To hide this reflection band, a second wavelength selective absorber can be added in front of the interference stack reflector as described previously. Other embodiments are also contemplated, including optical elements having two or more interference stack reflectors designed to have two or more reflection bands at a first selected angle, with any number of wavelength selective absorbing layers arranged to impart the desired angle selective properties to the optical element.

In some embodiments, the physical location of the wavelength selective absorber is designed to allow the optical element to have near-normal angle, high reflection in targeted portions of the visible spectrum, while providing for certain chosen reflection bands to be hidden by the wavelength selective absorber for angles of incidence that depart significantly from normal angles. In other embodiments, the angular selectivity of the reflection bands is designed to be at angles other than normal.

The optical elements disclosed herein provide high targeted reflectivity at wavelengths matching the projector light spectrum, and wherein the high targeted reflectivity is in a selected range of design angles. The optical elements minimize reflection of ambient light incident at angles other than the design angles via absorption by the wavelength selective absorbing layers. While a multilayer optical film without wavelength selective layers is selectively reflective in wavelength space, an optical element comprising a multilayer optical film with WSA layers can be both wavelength and angle selective. Presently disclosed optical elements used for high contrast front projection screens, displays, and security applications are characterized by having reflectivity that is both angle and wavelength selective.

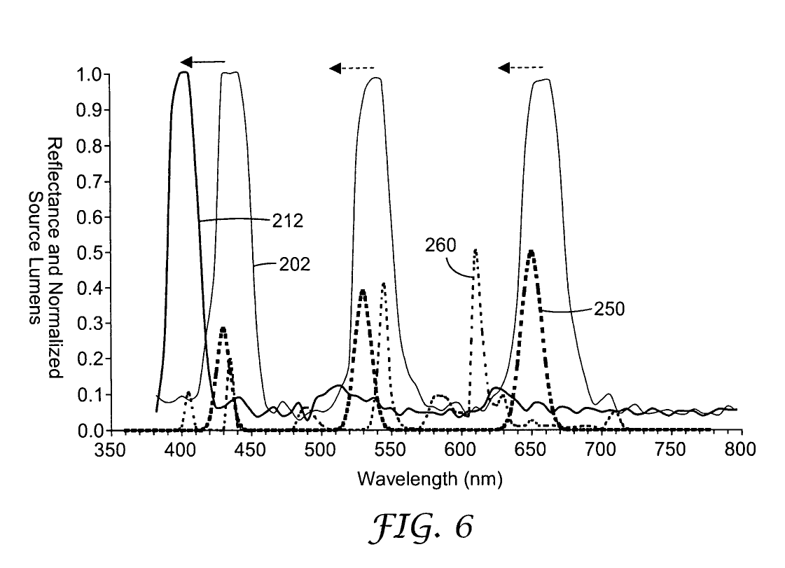

Optical elements having a selected number of reflection bands at a first angle of incidence and a different number of reflection bands at a second angle of incidence are disclosed. By hiding (absorbing) color-shifted reflection bands for angles other than the design angles of incident light, the number of reflection bands at the design angle can be selected to be different than the number of reflection bands at angles other than the design angles. As will be described in detail below, FIG. 6 shows an example of an optical element having three reflection bands at a design angle of 0° (curve 202) while having only a single reflection band for light incident at 40° (curve 212).

In some embodiments all the reflection bands in the visible wavelengths can be narrow reflection bands. In other embodiments, one or more narrow reflection bands can be combined with one or more broad reflection bands. Such combinations include multilayer optical films designed to include a first narrow reflection band and a second broad reflection band. An example of such an embodiment is shown in FIG. 13. In FIG. 13, a red reflection band 270 is a narrow reflection band while the second reflection band 272 is a broad reflection band in the blue-green portion of the visible spectrum. Such a multilayer optical film can be constructed, for example, from two distinct interference stacks, one contributing to the narrow red reflection band 270 and the other designed to reflect in the blue-green reflection band 272. To hide a color-shifted red reflection band, a wavelength selective absorber having an absorption edge 274 at about 620 nm can be added. In this embodiment, a second WSA to hide the blue color-shifted band can be omitted as that band moves into the ultraviolet range, where the human eye has no response.

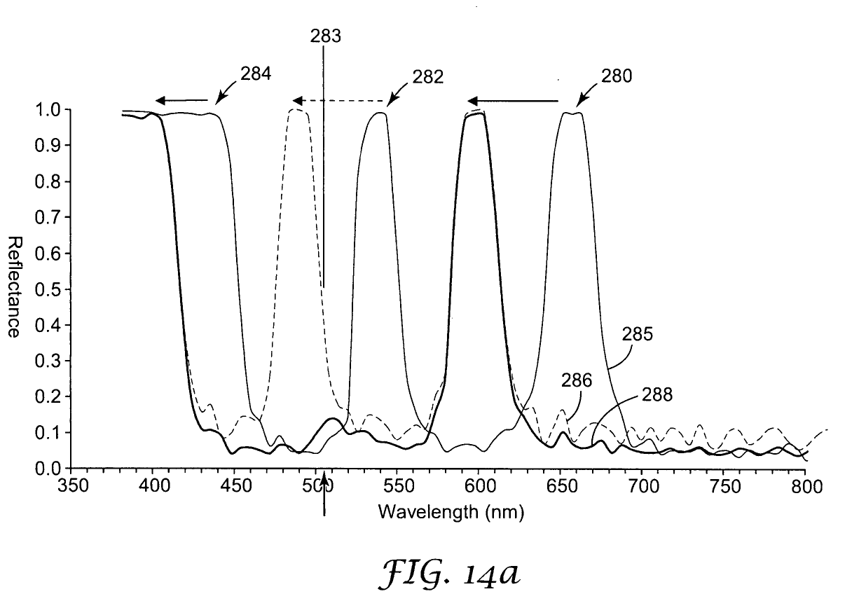

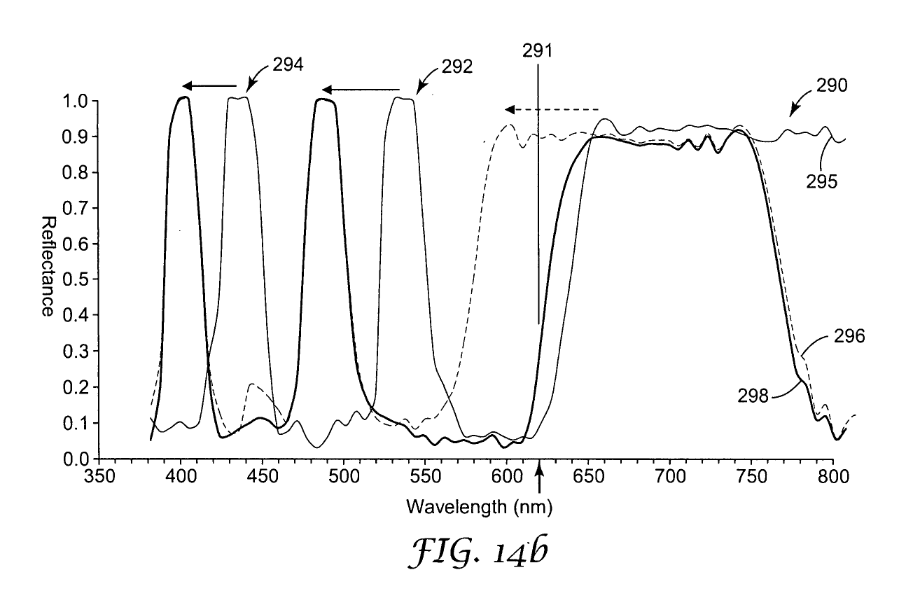

Other possible designs include reflection bands that extend beyond the visible, where the human eye has no response, therefore effectively making such bands narrow visible wavelength reflection bands. The reflection spectra for two alternative embodiments are shown in FIGS. 14a and 14b.

FIG. 14a shows a reflection spectrum 285 for a multilayer optical film with two narrow reflection bands 280 and 282 at normal incidence. These reflection bands can be higher order harmonic reflections of a 1^{st} order reflection outside the visible, or can be 1^{st} order reflections from two separate interference stacks. The third reflection band 284 is a broad reflection band extending into the ultraviolet wavelengths. For light incident at 40°, the color-shifted reflection bands are shown in reflection spectrum curve 286. To hide a color-shifted reflection band, a wavelength selective absorber having an absorption edge 283 at about 505 nm located between the green and blue reflection bands (282 and 284, respectively) can be used. To achieve this, the blue WSA is positioned between the green-reflecting interference stack and the broad-banded blue-reflecting interference stack within the optical element. Reflection curve 288 shows the reflection spectrum for an optical element of this design.

FIG. 14b shows the reflection spectra for an optical element of another embodiment. Here a first interference stack reflector is designed to have a wide reflection band 290 in the red wavelengths and extending outside the visible into the infrared wavelengths. A second multilayer optical film is designed to have two narrow reflection bands, one in the green and one in the blue wavelengths (292 and 294, respectively). As in the embodiment of FIG. 14a, these reflection bands can be higher order harmonic reflections of a 1^{st} order reflection outside the visible, or can be 1^{st} order reflections from two separate interference stacks. In this design, a WSA is selected to have an absorption edge 291 at about 620 nm to hide the color-shifted red reflection band for light incident outside the design angles. Reflection spectrum 295 shows the reflectance of the multilayer optical film of this design, with reflection bands 290, 292, and 294 at normal incidence angles. Reflection spectrum 296 shows the reflectance of the same multilayer optical film for light incident at 40°. In curve 296, all the reflection bands are shifted to shorter wavelengths, as indicated by the arrows. The reflection spectrum of an optical element including the multilayer film with the added wavelength selective absorber is shown as curve 298. In this curve, the color-shifted broad reflection band is changed to a narrower reflection band.

In embodiments using the optical element design shown in FIG. 4a, each MOF layer can be designed to have one or more reflection bands. In case of a single interference stack of polymeric microlayers, multiple reflection bands can be harmonics of a single first order reflection band. In designing an optical element for use in a projection screen, at least one of the reflection bands in each MOF layer should be in the visible range for a given design angle. For example, an optical element including three interference stack reflectors can be designed as shown in FIG. 4b. Another example is an optical element including two interference stack reflectors, one reflecting red and green light, the other reflecting blue light. Another example is an optical element including two interference stack reflectors where the first reflector has two reflection bands (e.g. blue and green) while a second reflector has a single red reflection band. In these examples, the reflection bands can be first order reflections or any higher order (harmonic) reflections. For example, a red reflection band can be a second order harmonic reflection of an infrared (IR) reflection band. Additional reflection bands outside the visible (such as IR bands) do not contribute to the optical element for viewing purposes, but could be used for other design considerations, if desired. For example, reflection bands outside the visible may be desirable for security applications where a non-visible light source is used, such as for authentication purposes.

While the present invention is frequently described herein with reference to the visible region of the spectrum, embodiments of the present invention can be used to operate at different wavelengths (and thus frequencies) of electromagnetic radiation through appropriate adjustment of various parameters (e.g., optical thickness of the optical layers and material selection.) Although some of the embodiments are described in context of a projection screen, the same techniques are applicable for optical elements used in other applications where high contrast is desired, including various displays (e.g. signage, active or dynamic display applications, and backlit displays) and security applications (e.g. product labels, proof of manufacture labels, and authentication tags).

For applications where flexibility is desirable, such as in a portable projection screen, for example, polymeric materials are preferred. An optical element constructed of polymeric materials can be made to be flexible and thus a projection screen having such an optical element can be easily rolled-up for storage or transport while not in use.

Using the principles described above, a variety of optical elements can be designed. Optical elements can include two or more interference stack reflectors and one or more wavelength selective absorbers interspersed as layers between selected pairs of adjacent interference stack reflectors. As the reflection bands of each of the MOF layers shift for angles other than the design angles, the wavelength selective absorbers can be selected to hide the color-shifted reflection bands. This allows the optical element to be both wavelength selective and angle selective. A high contrast application, such as a front projection screen or display utilizing any of the optical elements described herein, provides higher contrast by reflecting substantially all of the projected light which enters the screen in a first range of angles, while maximizing absorption of ambient light, incident in a second range of angles. The first range of angles can be near-normal angles or another design angle range.

Although specific embodiments have been described in detail, other embodiments are also contemplated. For example, an optical element having two interference stack reflectors with a single wavelength selective absorber can also be designed to reflect in any two wavelength ranges, not limited to the red, green, and blue in the exemplary embodiments above. Optional additional layers can also be added without departing from the spirit and scope of the invention. For example, a black absorbing layer can be added behind the multilayer optical film. Similarly a diffusing layer can be added on the incident side of the optical element to change the angular distribution of light reflected by the optical element into an appropriate viewing angle. Optional additional layers or coatings include UV protective layers, scratch resistant layers, hard coats, etc.

Contrast ratio for a front projection screen characterizes the reflection efficiency of the projected image, relative to the reflection efficiency of the ambient light in the projection environment. Exact values of contrast ratio for a screen depend on the projector output (lumens), the screen size, the ambient light source spectra and illuminance, and to some degree screen gain. Generally, standard “white” beaded projection screens are characterized to have normal angle contrast ratios of approximately 2:1 for typical office projection environments and standard HTPS or DLP projectors. Some commercially available high contrast front projection screens have been characterized as having viewing angle contrast ratios ranging from 10:1 to 20:1, for similar projection scenarios. As shown in the examples below, screens using the optical elements comprising the multilayer optical film and wavelength selective absorber(s) disclosed herein can achieve contrast ratios that are improved by approximately 100% (i.e. doubled) when compared to a screen of similar design but without the wavelength selective absorber(s).

### EXAMPLES

### Example 1

In Example 1, an optical element comprising a multilayer optical film mirror is computationally constructed (i.e. modeled). The MOF structure consists of 3 coherent multilayer optical film quarterwave stacks, each with 160 layers of polycarbonate (material 1) and PMMA (material 2). All materials in Example 1 are isotropic, with refractive indices n₁=1.579 and n₂=1.495. The lower index PMMA layers are at the air to interference stack reflector interfaces. These act to lower the reflection level in wavelength regions between interference stack reflection bands. Each of the groups of coherent stacks of alternating polymeric microlayers (herein referred to as “blue-reflecting interference stack”, “green-reflecting interference stack”, etc. . . . ) is designed to have a reflection band around a design visible wavelength. Equation 1 shows the relationship between the first-order harmonic (m=1) reflection band center-wavelength λ_{0,m}, the physical thicknesses d_{1,i} and d_{2,i} of the microlayers in each interference stack reflector, as well as the refractive index values n₁ and n₂ of the two materials comprising the repeating microlayers. In this design example, a very low gradient, close to 1, is chosen, so that all of the unit cells (quarterwave pairs of material 1 and 2) are resonate at about the same wavelength. This acts to make the first-order reflection bands relatively narrow in the visible.

$${λ}_{0 , m} = ( 2 / m ) ( {n}_{1} {\sum }_{i = 1 , j} {d}_{1 , i} + {n}_{2} {\sum }_{i = 1 , j} {d}_{2 , i} ) \qquad Equation 1$$

The wavelength location of each interference stack's first order reflection band is chosen in this Example to be matched to a projector having emission peaks in the red, green, and blue wavelengths. In this example the projected light spectrum is assumed to be an LED-type narrow banded spectrum, delivering Gaussian-shaped peaks centered at 430 nm, 530 nm, and 650 nm wavelengths. FIG. 2 shows the MOF reflection spectrum 200a at normal incidence angles (without WSA layers), and the projected light spectrum 250.

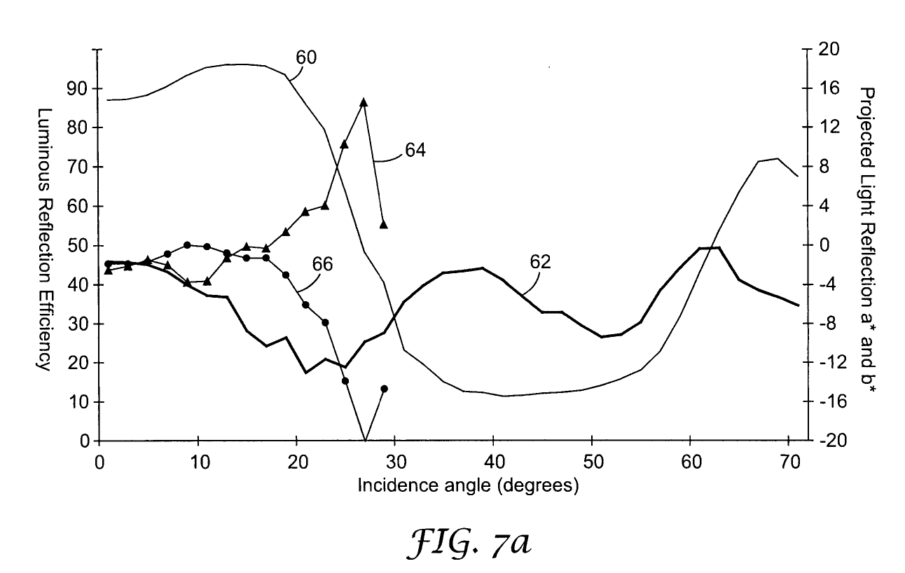

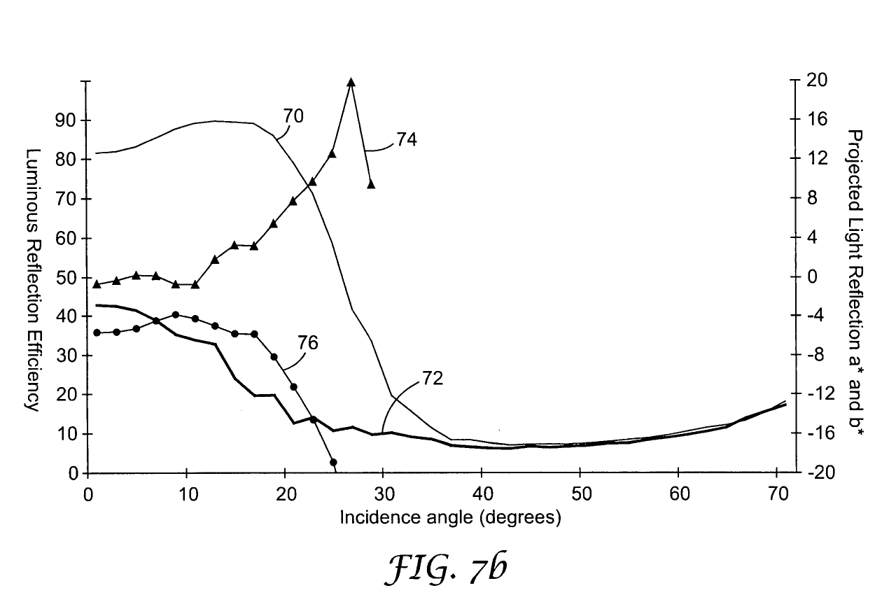

By calculating the spectrum of the multilayer optical film across a range of incidence angles, and using a colorimetric analysis tool, one can plot the luminous reflectance, and the projected light color change, for a range of incidence angles. FIG. 7a shows the luminous reflection efficiency 60 for the projected light spectrum and color change of the projected light upon reflection by the MOF body (a* value 64 and b* value 66), as a function of incidence angle for the multilayer optical film alone. The projected light color change is calculated using the CIE Lab chromaticity system. Also shown is the luminous reflection efficiency 62 of a compact fluorescent source (representing a typical ambient light source) as a function of incidence angle for the same multilayer optical film.

In FIG. 7a, the projected light color change a* value 64 and b* value 66 show relatively small changes in the angle-range appropriate to front projection screens with a near-normal design angle (0 to 20 degrees), and the luminous reflection efficiency 60 for the projected light is near 90% in that range. The area under the compact fluorescent luminous reflection curve 62, to a first approximation, represents potentially contrast-reducing reflected ambient light. One of the technical challenges of designing a high contrast front projection screen, is to make the reflection for any ambient source light, very low across interaction angles that could potentially reflect light into the audience viewing angle range.

The luminous reflection efficiency 62 of the ambient fluorescent light rises at angles greater than 20° because the reflection bands of the multilayer optical film shift into regions of the fluorescent source spectra that contribute strongly to luminous reflection. The significant contributors to the fluorescent reflection with angle are the red and the green reflection bands.

A method to mitigate this contrast-reducing effect is to cause the red and the green reflection bands to shift into an absorption edge, as incidence angle is increased. A computational design wherein wavelength-selective absorption layers are interleaved with the interference stack reflectors, is discussed below. The WSA layers were modeled after commercially available visible dye absorbing long wavelength pass filters (e.g. Filtron E-520 and Filtron E-620 dye-loaded acrylic and polycorbonate plate products). Other extrudable dyes and pigments that can generate wavelength selective absorbers that have sharp visible absorption bandedges, are commercially available. FIG. 5 shows the transmission spectra of the WSA layers used for the optical elements in Examples 1 and 2.

When the optical element includes an MOF structure with a series of wavelength selective absorbers located in an appropriate sequence, as for example in FIG. 4b, some of the reflection bands of the optical element become hidden (absorbed) with increasing incidence angle. FIG. 6 shows a computational reflection spectrum 202 for an optical element including interference stack reflectors, WSA layers, and a black absorbing layer arranged as shown in FIG. 4b. At normal incidence, the spectrum 202 shows three reflection bands, at wavelengths similar to those shown previously in FIG. 2. At an incidence angle of 40°, however, the spectrum 212 has only one reflection band corresponding to the blue color-shifted reflection band of FIG. 2. FIG. 6 shows an optical element comprising three interference stack reflectors with two interspersed WSA layers, the optical element designed to have three reflection bands at normal incidence angles and only a single reflection band for light incident at 40°.

Using these methods optical elements comprising interference stack reflectors with interspersed WSA layers can be designed to have a first number n of reflection bands at one angle of incidence, while having a different, second number of reflection bands at another angle of incidence. This design yields an optical element having both wavelength selectivity and angular selectivity. Those skilled in the art will appreciate how various interference stack reflectors can be combined with various WSA layers to create an optical element having reflection properties for certain chosen design wavelengths and angles, while absorbing other wavelengths and angles. Using the design described in this example, the significant contributors to the fluorescent reflection are absorbed at angles greater than 30°.

As before, by calculating the reflection spectrum of the multilayer optical film across a range of incidence angles, and using a colorimetric analysis tool, one can plot the luminous reflectance, and the projected light color change, for the range of interaction angles that are appropriate for the optical element (including the WSA layers) in a front projection screen. FIG. 7b shows the luminous reflection efficiency 70 for the projected light spectrum and color change of the projected light upon reflection by the optical element (a* value 74 and b* value 76), as a finction of incidence angle. The luminous reflection efficiency of the fluorescent source 72 shows a significant reduction at angles greater than approximately 25°, as the red and green reflectance bands no longer contribute to reflection at those angles. The area under the fluorescent luminous reflection curve 72 again shows the amount of contrast-reducing ambient light reflected by the optical element. When the WSA layers are interleaved between the interference stack reflectors, the total fluorescent reflection is reduced substantially (approximately a factor of 3). The optical element of this design has high, targeted reflectivity at near-normal angles (projector design angle), but becomes an absorptive structure at all other angles associated with stray, ambient light of any type.

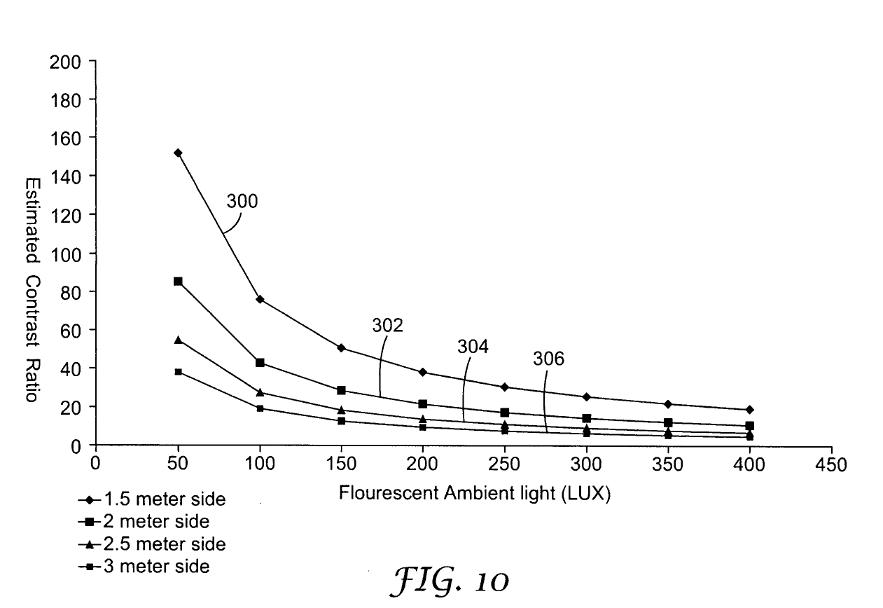

FIG. 10 shows an estimate of contrast ratio using the optical element of this example. An estimate of contrast ratio can be done by estimating the viewing angle (near screen normal) image brightness and normalizing by the ambient light brightness (reflected into the near-normal solid angle), assuming the ambient light output is distributed equally around the front hemisphere of the screen. FIG. 10 shows estimated contrast ratio for varying ambient light illuminance (assuming a compact fluorescent light spectrum). The projector output is taken as 1000 Lumens. The four curves represent four different sizes of screens: 1.5 meters per side (curve 300), 2.0 meters per side (curve 302), 2.5 meters per side (curve 304), and 3 meters per side (curve 306).

The optical effects of an optional diffluser overlay on the optical element will change the angular characteristics for the MOF reflection response and the redirection of ambient light. In particular, higher propagation angles through the MOF structure may result if the diffuser overlay is in optical contact with the MOF. These optical effects will depend in detail on the diffusive characteristics of the diffusive overlay.

### Example 2

In Example 2, an MOF reflective polarizer is computationally constructed. The MOF structure consists of three coherent multilayer quarterwave stacks, each with 160 microlayers of a birefringent polyethylene naphthalate (PEN; material 1) having refractive index in a stretch direction of n_{1,stretch}=1.757 and a refractive index in a matched direction of n_{1,match}=1.614; and non-birefringent copolymer of PEN (co-PEN; material 2) having a refractive index n₂=1.612. The lower index co-PEN layers are assumed to be at the air to interference stack interfaces. This acts to lower the reflection level in wavelength regions between interference stack reflection bands. As with the MOF mirror in Example 1, each of the coherent interference stacks is designed to have a reflection band at a design visible wavelength, matched to the projector light output spectrum. Equation 1 shows the relationship between first harmonic reflection wavelength (m=1), and physical thickness of the layers in each interference stack, for the in-plane material axis with the refractive index mismatch due to strain-hardening birefringence. Along the orthogonal in-plane axis, the birefringent PEN refractive index is substantially matched with the isotropic co-PEN refractive index, resulting in substantially no coherent reflection.

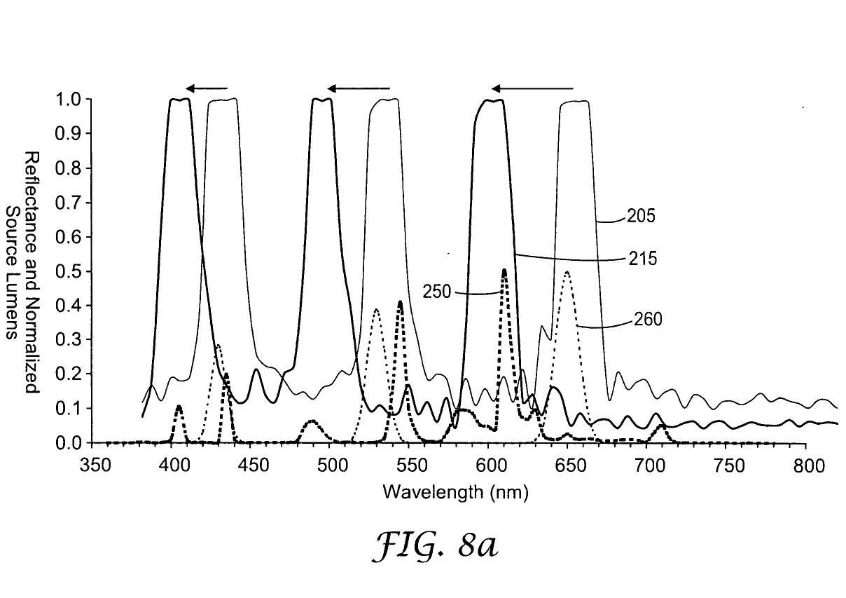

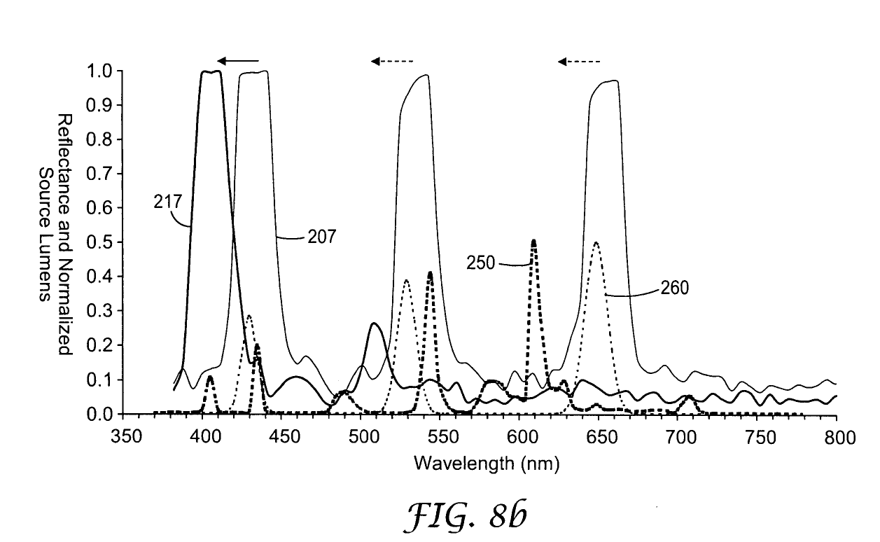

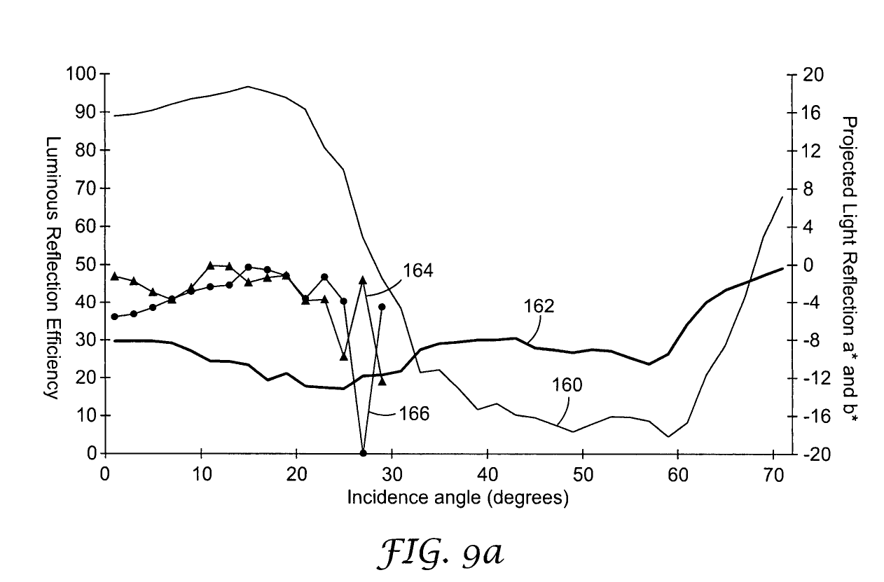

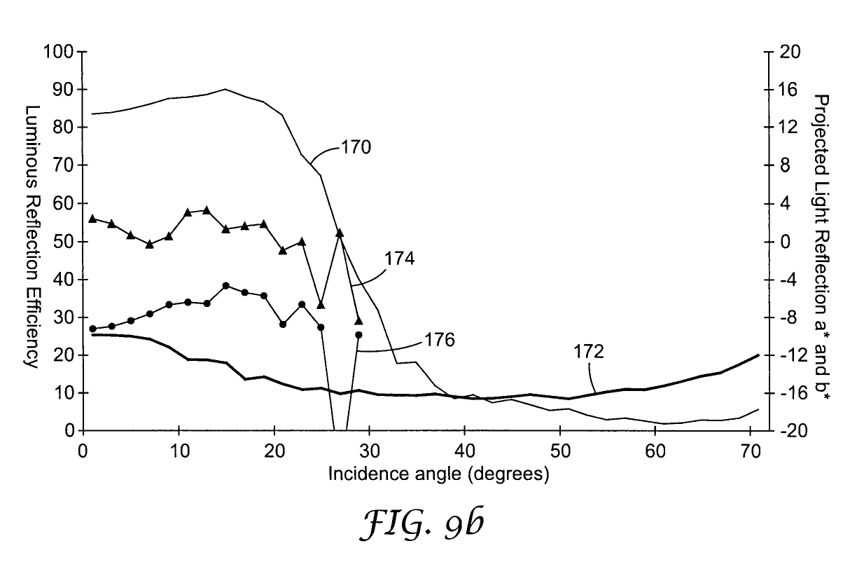

FIG. 8a shows the reflection spectra for an optical element composed of three reflective polarizer interference stacks without any WSA layers. Curve 205 shows the normal angle reflection spectrum for linearly polarized incident light with its electric field laying in a normal plane that contains the material axis with substantially mismatched refractive indices. Curve 215 shows the reflection spectrum at an incidence angle of 40°. By calculating the MOF reflective polarizer reflection spectrum across a range of incidence angles, and using a colorimetric analysis tool, one can plot the luminous reflectance, and the source color change, for the range of incidence angles and polarization state, where the projector's light output polarization is matched to the MOF polarization axis with substantial refractive index mismatch. FIG. 9a shows the luminous reflection efficiency 160 and the projector light color change (a* value 164 and b* value 166), as a function of incidence angle for reflection from this optical element. Also shown is the luminous reflection efficiency 162 of a compact fluorescent source as a function of incidence angle, where the fluorescent polarization state is assumed to be random.

In FIG. 9a, a* value 164 and b* value 166 show only small changes in the angle range appropriate to front projection screens (0-20°), indicating substantially no change to the projected light white state, and luminous reflection efficiency 160 for the RGB source is above 90% in that range. The area under the compact fluorescent luminous reflection curve 162, to a first approximation, is potentially contrast-reducing reflected light.

The WSA layers were added to the MOF reflective polarizer structure, positioned in an appropriate sequence (see FIG. 4b), so that the reflection bands become hidden (absorbed) with increasing incidence angle. FIG. 8b shows a computational reflection spectrum 207 for an optical element including a co-extruded polymeric MOF reflective polarizer, WSA layers, and a black absorbing layer arranged as shown in FIG. 4b. FIG. 9b shows the reflection efficiency 170 of such an optical element for a linearly polarized projector light source. When the WSA layers are interleaved with the interference stack reflectors, the total fluorescent reflection is reduced substantially as in Example 1. The optical element of this design has high, targeted reflectivity at near-normal angles (projector angles), but becomes an absorptive structure at all other angles associated with stray, ambient light of any type.

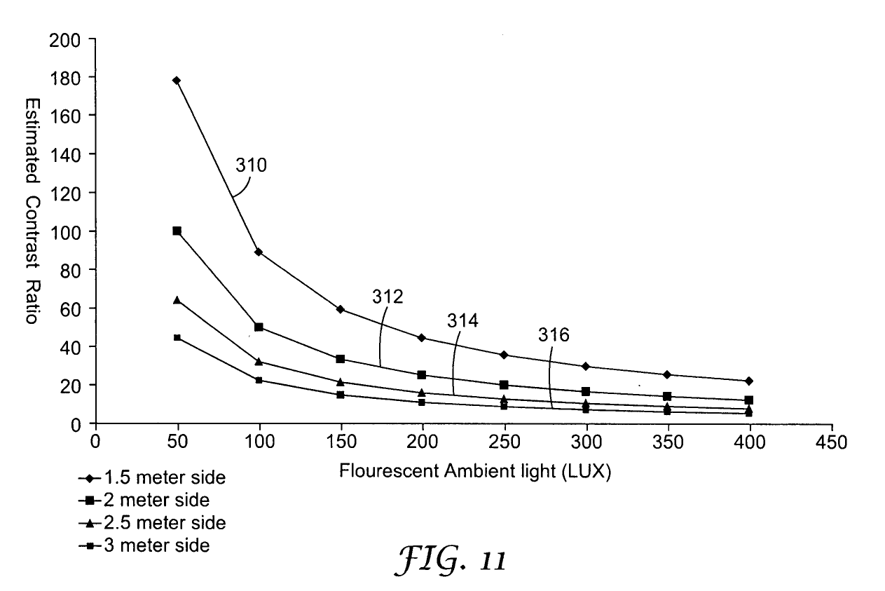

An estimate for the front projection screen contrast ratio, where Example 2 provides the optical element with a reflective polarizer function (assuming the projected spectrum has a linear polarization state, aligned with the mismatched refractive index material axis), is shown in FIG. 11. FIG. 11 shows estimated near-normal angle screen contrast ratio for varying ambient light illuminance (assuming a compact fluorescent light spectrum). The projector output is 1000 Lumens. The four curves represent four different sizes of screens: 1.5 meters per side (curve 310), 2.0 meters per side (curve 312), 2.5 meters per side (curve 314), and 3 meters per side (curve 316).

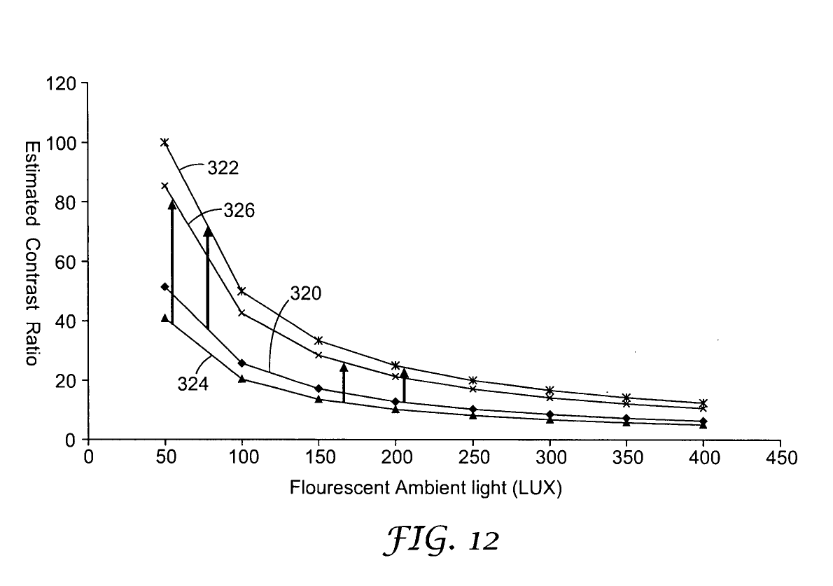

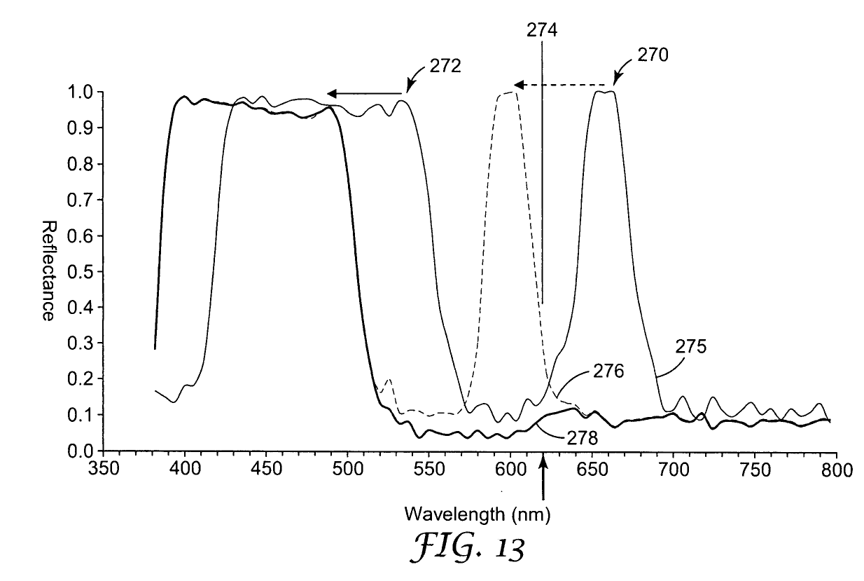

FIG. 12 shows the increase in estimated contrast ratio generated by including the WSA layers interleaved with the interference stacks of the MOF. The improvement of estimated contrast ratio is a factor of 2, for the optical element of Example 1 and for the optical element of Example 2. The projector output is 1000 Lumens and the screen size is 2 meters per side. Curve 320 shows estimated contrast ratio for varying of ambient light conditions for the polymeric reflective polarizer of Example 2 with no wavelength selective absorbers. Curve 322 shows estimated contrast ratio for the polymeric reflective polarizer of Example 2 with the wavelength selective absorbers. Comparing these curves at, for example, ambient light at 100 lux, a reflective polarizer without WSA layers (curve 320) has an estimated contrast ratio of about 25 while the same reflective polarizer with interleaved WSA layers has an estimated contrast ratio of 50. Similarly, curves 324 and 326 show estimated contrast ratio for the mirror MOF structure of Example 1 without the WSA layers (curve 324) and with the WSA layers (curve 326). A similar contrast ratio increase of approximately 100% is achieved. At fluorescent ambient light of 100 lux, the MOF mirror without WSA layers has an estimated contrast ratio of 20 while the same MOF mirror with WSA layers has an estimated contrast ratio of approximately 42.

When a screen is designed including the optical elements containing the wavelength selective absorber(s) described herein, such a screen is estimated to have a contrast ratio improved by approximately 100% (or doubled) as compared to a screen of similar design but without the wavelength selective absorber(s). Similar contrast ratio improvements are expected for display devices and security application incorporating the optical elements disclosed herein.

While the invention is amenable to various modifications and alternative forms, specifics thereof have been shown by way of example in the drawings and the detailed description. It should be understood, however, that the intention is not to limit the invention to the particular embodiments described. On the contrary, the intention is to cover modifications, equivalents, and alternatives falling within the spirit and scope of the invention as defined by the appended claims. All patents and patent applications that are referred to herein and are co-owned as of the date of filing of the present application are incorporated by reference, to the extent they are not inconsistent with the foregoing disclosure.

What is claimed is:

1. An optical element, comprising:
a multilayer optical film having a plurality of reflection bands at design wavelengths of incident light, wherein at least one of the reflection bands is a narrow reflection band, wherein each reflection band has a nominal spectral position at a design angle of incidence and wherein each reflection band shifts to a color-shifted reflection band for light incident at angles other than the design angle; and
a wavelength selective absorber for absorbing light in at least one of the color-shifted reflection bands.

2. The optical element of claim 1, wherein the optical element has n reflection bands at the design angle of incidence and less than n color-shifted reflection bands.

3. The optical element of claim 1, wherein the reflection bands include a red, a green, and a blue reflection band at the design angles of incidence.

4. The optical element of claim 1, wherein the design angle of incidence is 0°.

5. The optical element of claim 1, wherein the multilayer optical film is a reflective polarizer.

6. The optical element of claim 1, wherein the optical element is characterized by an angular distribution of reflected light, the optical element further comprising a diffusing element for changing the angular distribution of reflected light.

7. A screen including the optical element of claim 1, the screen characterized by a contrast ratio wherein the contrast ratio is improved by approximately 100% compared to a screen of similar design but without the wavelength selective absorber.

8. A system comprising:
a light source for projecting light; and
a screen including the optical element of claim 1, for reflecting the projected light.

9. The system of claim 8, wherein the optical element is tuned to the light source at the design angle of incidence.

10. An optical element, comprising:
a multilayer optical film including two interference stack reflectors, wherein the multilayer optical film has two narrow reflection bands for light at a first angle of incidence and wherein the multilayer optical film has two color-shifted reflection bands for light at a second angle of incidence; and
a wavelength selective absorbing (WSA) layer disposed between the two interference stack reflectors, the WSA layer having an absorption edge selected to hide at least one of the color-shifted reflection bands.

11. The optical element of claim 10, wherein the first angle of incidence is a near-normal angle of incidence.

12. The optical element of claim 10, wherein the optical element has n reflection bands at the first angle of incidence and less than n reflection band at the second angle of incidence.

13. The optical element of claim 10, further comprising a black WSA layer disposed behind the multilayer optical film.

14. The optical element of claim 10, further comprising a diffusing layer disposed in front of the multilayer optical film.

15. A screen including the optical element of claim 10, the screen characterized by a contrast ratio wherein the contrast ratio is improved by approximately 100% compared to a screen of similar design but without the wavelength selective absorber.

16. An optical element, comprising:
a blue-light reflecting interference stack;
a green wavelength selective absorber disposed behind the blue-light reflecting interference stack;
a green-light reflecting interference stack disposed behind the green wavelength selective absorber;
a red wavelength selective absorber disposed behind the green-light reflecting interference stack; and
a red-light reflecting interference stack disposed behind the red wavelength selective absorber.

17. The optical element of claim 16, further comprising a black WSA disposed behind the red-light reflecting interference stack.

18. The optical element of claim 16, further comprising a diffusing layer disposed in front of the blue-light reflecting interference stack.

19. A screen including the optical element of claim 16, the screen characterized by a contrast ratio wherein the contrast ratio is improved by approximately 100% compared to a screen of similar design but without the wavelength selective absorber.
